(19) United States
(12) Patent Application Publication
(10) Pub. No.: US 2025/0341008 A1
(43) Pub. Date: Nov. 6, 2025

(54) ELECTROCATALYSTS AND METHODS OF MAKING AND USING SAME

(71) Applicant: Duke University, Durham, NC (US)

(72) Inventors: Ivan A. Moreno-Hernandez, Durham, NC (US); Conner Jeffrey Soderstedt, Palmyra, PA (US)

(21) Appl. No.: 19/193,254

(22) Filed: Apr. 29, 2025

Related U.S. Application Data
(60) Provisional application No. 63/641,124, filed on May 1, 2024.

(51) Int. Cl. C25B 11/077; C25B 11/093; H01M 4/88; H01M 4/90

(52) U.S. Cl. CPC C25B 11/0775; C25B 11/093; H01M 4/88; H01M 4/9033

(57) ABSTRACT

Described herein are catalysts, methods of making same, and methods of using same. The catalysts are stable and especially useful for catalyzing anodic reactions in acidic electrolytes.

### CROSS-REFERENCE TO RELATED APPLICATIONS

This application claims priority to U.S. Provisional Patent Application No. 63/641,124, filed on May 1, 2024, the contents of which are hereby incorporated by reference herein.

### FIELD OF INVENTION

Described herein are catalysts, methods of making same, and methods of using same. The catalysts are stable and especially useful for catalyzing anodic reactions in acidic electrolytes.

### BACKGROUND

A key effort in the advancement of alternative fuel technologies is the development of electrochemical devices that facilitate the generation of fuels via interfacial electron transfer. A bottleneck in the development of these devices is the discovery of electrocatalyst materials for the oxygen evolution reaction (OER) in acidic conditions that simultaneously fulfill three critical criteria: they must be scalable, have a high activity, and have excellent durability. While many electrocatalytic materials display a subset of these desirable properties, no known material fulfills all three criteria for the acidic OER. Noble metal oxides, such as IrO₂ and RuO₂, display a balance of activity and durability, but suffer from issues with scalability due to their low crustal abundance that are exacerbated by dissolution pathways during electrocatalysis.

The current state-of-the-art OER catalysts in acid include noble metal oxides such as iridium (IrO₂) and ruthenium (RuO₂) oxides. The abundance of these elements on earth is extremely limited, which makes them expensive and not scalable, and they have also demonstrated instability in acidic conditions. Ideally, an earth abundant catalyst will be found to replace these noble metal oxide catalysts, however, currently available earth abundant OER catalysts possess overpotentials far higher than their noble metal counterparts.

Another approach that has been used is to dope the noble metals with existing materials, such as Mn, Co, or Ni oxides, and while this approach does show promise it still results in high noble metal usage.

An alternative strategy is to synthesize electrocatalyst materials that contain small amounts of noble metals in order to improve catalytic activity while reducing noble metal usage. For example, there has been extensive research done in using a non-noble metal substrate to support noble metal active sites. However, the results of these research endeavors have not yet yielded desirable results.

Hence, advances in electrocatalytic materials are needed to meet the goal of scalable on-demand production of fuels.

### BRIEF DESCRIPTION

In one embodiment of the present disclosure, provided herein is an electrocatalyst, comprising: a first-row transition metal; antimony; a noble metal; and oxygen.

In another embodiment of the present disclosure, provided herein is a method of making an electrocatalyst, comprising: a first-row transition metal; antimony; a noble metal; and oxygen. The method comprises incorporating the noble metal into a precursor framework comprising the first-row transition metal, antimony, and oxygen.

In yet another embodiment of the present disclosure, provided herein is a method of using an electrocatalyst, comprising: a first-row transition metal; antimony; a noble metal; and oxygen. The method comprises catalyzing an industrial application with the electrocatalyst.

### BRIEF DESCRIPTION OF DRAWINGS

The patent or application file contains at least one drawing executed in color. Copies of this patent or patent application publication with color drawing(s) will be provided by the Office upon request and payment of the necessary fee.

These and other features, aspects, and advantages of the present disclosure will become better understood when the following detailed description is read with reference to the accompanying drawings. These drawings are exemplary and are not to be construed as limiting.

FIG. 1A depicts a schematic molten salt synthetic pathway for low-iridium electrocatalysts in accordance with the present disclosure.

FIG. 1B depicts transmission electron microscopy (TEM) imaging of a highly crystalline structure and nanorod morphology of Ir_{0.1}Mn_{0.3}Sb_{0.6}O₂ nanocrystals in accordance with the present disclosure.

FIG. 1C depicts Ir_{0.25}Mn_{0.25}Sb_{0.5}O₂ nanocrystals in accordance with the present disclosure, which exhibit improved efficiency compared to IrO₂ nanocrystals.

FIG. 1D depicts proton exchange membrane (PEM) electrolyzers with Ir_{0.1}Mn_{0.3}Sb_{0.6}O₂ anodes in accordance with the present disclosure, which exhibit sustained efficiency compared to IrO₂ anodes at 250 mA cm⁻²

FIG. 2A depicts a TEM image of a manganese antimony oxide nanocrystal in accordance with the present disclosure.

FIG. 2B depicts electron diffraction of manganese antimony oxide in accordance with the present disclosure

FIG. 2C depicts a TEM image of a Ir_{0.25}Mn_{0.25}Sb_{0.5}O₂ nanocrystal in accordance with the present disclosure.

FIG. 2D depicts electron diffraction of Ir_{0.25}Mn_{0.25}Sb_{0.5}O₂ in accordance with the present disclosure.

FIG. 2E depicts a TEM image of a Ru_{0.25}Mn_{0.25}Sb_{0.5}O₂ nanocrystal in accordance with the present disclosure.

FIG. 2F depicts electron diffraction of Ru_{0.25}Mn_{0.25}Sb_{0.5}O₂ in accordance with the present disclosure.

FIG. 2G depicts a TEM image of a RuO₂ nanocrystal in accordance with the present disclosure.

FIG. 2H depicts a TEM image of a IrO₂ nanocrystal in accordance with the present disclosure.

FIG. 3A depicts O is and Sb(V) peaks with corresponding fits in X-ray photoelectron spectroscopy (XPS) characterization of Ir_{0.25}Mn_{0.25}Sb_{0.5}O₂ nanocrystals in accordance with the present disclosure.

FIG. 3B depicts Mn(II) peaks with corresponding fits in XPS characterization of Ir_{0.25}Mn_{0.25}Sb_{0.5}O₂ nanocrystals in accordance with the present disclosure.

FIG. 3C depicts Ir (IV) peaks with corresponding fits in XPS characterization of Ir_{0.25}Mn_{0.25}Sb_{0.5}O₂ nanocrystals in accordance with the present disclosure.

FIG. 3D depicts O is and Sb(V) peaks with corresponding fits in X-ray photoelectron spectroscopy (XPS) characterization of Ru_{0.25}Mn_{0.25}Sb_{0.5}O₂ nanocrystals in accordance with the present disclosure.

FIG. 3E depicts Mn(II) peaks with corresponding fits in XPS characterization of Ru_{0.25}Mn_{0.25}Sb_{0.5}O₂ nanocrystals in accordance with the present disclosure.

FIG. 3F depicts Ru (IV) and C is peaks with corresponding fits in XPS characterization of Ru_{0.25}Mn_{0.25}Sb_{0.5}O₂ nanocrystals in accordance with the present disclosure.

FIG. 4A depicts cyclic voltammetry of Ir-doped MnSb₂Oₓ at a scan rate of 10 mV sec⁻¹ and loading of 125 μg cm⁻² in accordance with the present disclosure.

FIG. 4B depicts cyclic voltammetry of Ru-doped MnSb₂Oₓ at a scan rate of 10 mV sec⁻¹ and loading of 125 μg cm⁻² in accordance with the present disclosure.

FIG. 4C depicts overpotential at 0.1 mA cm⁻²ₒₓ for Ir-doped MnSb₂Oₓ in accordance with the present disclosure.

FIG. 4D depicts overpotential at 0.1 mA cm⁻²ₒₓ for Ru-doped MnSb₂Oₓ in accordance with the present disclosure.

FIG. 4E depicts an image of a PEM device used in accordance with the present disclosure.

FIG. 4F depicts cyclic voltammetry of Ir_{0.1}Mn_{0.3}Sb_{0.6}O₂ initially and after 723 hours of operation compared to IrO₂ initially and after 685 hours of operation in accordance with the present disclosure.

FIG. 4G depicts chronopotentiometry of Ir_{0.1}Mn_{0.3}Sb_{0.6}O₂ and IrO₂ at 250 mA cm⁻² in accordance with the present disclosure.

FIG. 5 depicts cyclic voltammetry of MnSbIrOₓ, MnSbRuOₓ, and IrOₓ electrocatalysts synthesized at 500° C. and tested electrochemically in 1.0 M perchloric acid in accordance with the present disclosure.

FIG. 6 depicts cyclic voltammetry of ZnSbRuOₓ, CuSbRuOₓ, MnSbRuOₓ, ZnSbIrOₓ, CuSbIrOₓ, and MnSbIrOₓ electrocatalysts synthesized at 700° C. and tested electrochemically in 1.0 M perchloric acid in accordance with the present disclosure.

FIG. 7 depicts cyclic voltammetry of RuO₂, CuSbRuOₓ, ZnSbIrOₓ, ZnSbRuOₓ, MnSbIrOₓ, and MnSbRuOₓ electrocatalysts tested electrochemically in a two-compartment cell including 4.0 M NaCl at pH=1.75 in an anode compartment and 0.1 M NaOH in a cathode compartment in accordance with the present disclosure.

FIG. 8 depicts resistance-corrected potential over time of a proton-exchange membrane electrolyzer operating at 250 mA cm⁻² with a MnSbIrOₓ electrocatalyst in an anode, a Nafion membrane, and a Pt/C electrocatalyst in a cathode in accordance with the present disclosure.

FIG. 9A depicts cyclic voltammetry curves for MISO-700° C. samples compared to synthesized IrO₂ at a 10 mV s⁻¹ scan rate and 500 μg cm⁻² catalyst loading in 1.0 M HClO₄ in accordance with the present disclosure.

FIG. 9B depicts overpotentials at 10 mA cm⁻² for the MISO-700° C. catalysts and IrO₂ in accordance with the present disclosure.

FIG. 9C depicts normalized overpotentials at 0.1 mA cm⁻²ₒₓ for the MISO-700° C. catalysts and IrO₂ in accordance with the present disclosure.

FIG. 9D depicts Tafel plots of MISO-700° C. catalysts and IrO₂ with a 500 μg cm⁻² catalyst loading in accordance with the present disclosure.

FIG. 9E depicts cyclic voltammetry curves for MRSO-700° C. samples compared to synthesized RuO₂ at a 10 mV s⁻¹ scan rate and 500 μg cm⁻² catalyst loading in 1.0 M HClO₄ in accordance with the present disclosure.

FIG. 9F depicts overpotentials at 10 mA cm⁻² for the MRSO-700° C. catalysts and RuO₂ in accordance with the present disclosure.

FIG. 9G depicts normalized overpotentials at 0.1 mA cm⁻²ₒₓ for the MRSO-700° C. catalysts and RuO₂ in accordance with the present disclosure.

FIG. 9H depicts Tafel plots of MRSO-700° C. catalysts and RuO₂ with a 500 μg cm⁻² catalyst loading in accordance with the present disclosure.

FIG. 10A depicts STEM-EDS images showing signal from Mn (green), Ir (red), Sb (blue), and O (orange) in accordance with the present disclosure.

FIG. 10B depicts high resolution O is and Sb 3d region scan for 25-MISO-700° C., 25-MRSO-700° C. and MnSbOₓ in accordance with the present disclosure.

FIG. 10C depicts high resolution spectra for the Ir 4f region for 25-MISO-700° C. in accordance with the present disclosure.

FIG. 10D depicts high resolution spectra for the Ru 3d region for 25-MRSO-700° C. in accordance with the present disclosure.

FIG. 10E depicts high resolution spectra for the Mn²p_{3/2} region for 25-MISO-700° C., 25-MRSO-700° C. and MnSbOₓ in accordance with the present disclosure.

FIG. 10F depicts high magnification STEM image of 25-MISO synthesized at 700° C. in accordance with the present disclosure.

FIG. 10G depicts a model of a nanocrystal of 25-MISO with blue being iridium, pink being antimony, green being manganese, and red being oxygen showing the {110), {111} and {001} facets in accordance with the present disclosure.

FIG. 11A depicts cyclic voltammetry curves taken pre- and post-operation for 25-MISO-700° C. and IrO₂ at 10 mV s⁻¹ in accordance with the present disclosure.

FIG. 11B depicts a chronopotentiometry test at 250 mA cm⁻² for 25-MISO-700° C. and IrO₂ in accordance with the present disclosure.

FIG. 11C depicts faradaic efficiency of 25-MISO-700° C. in accordance with the present disclosure.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The present disclosure incorporates the development and validation of scalable electrocatalyst materials for the OER, a critical component of the generation of H₂, and the development of models of intermediate binding energies that are consistent with experimental measurements of electrochemical activity, thereby lending insight into reaction pathways.

It has been discovered that a transition metal doped antimonate may be used as a support for noble metal active sites, in order to maintain the rutile crystal structure and result in a stable and active low noble metal OER electrocatalyst.

Disclosed herein is a class of materials that exhibit high activity towards anodic reactions and high stability in acid.

In one aspect, the present disclosure provides an electrocatalyst comprising a first-row transition metal, antimony, a noble metal, and oxygen.

In one embodiment, the first-row transition metal is selected from the group consisting of titanium (Ti), vanadium (V), chromium (Cr), manganese (Mn), iron (Fe), cobalt (Co), nickel (Ni), copper (Cu), zinc (Zn), and combinations thereof.

In another embodiment, the noble metal is selected from the group consisting of ruthenium (Ru), rhodium (Rh), palladium (Pd), silver (Ag), osmium (Os), iridium (Ir), platinum (Pt), gold (Ag), and combinations thereof. In some embodiments, the noble metal comprises ruthenium (Ru) and/or iridium (Ir).

In one aspect, the electrocatalyst has a chemical composition according to Formula I:

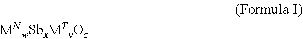

wherein:
M^{N} represents the noble metal;
M^{T} represents the first-row transition metal;
w is in a range of from about 0.05 to about 0.90;
x is in a range of from about 0.05 to about 0.90;
y is in a range of from about 0.05 to about 0.90; and
z is in a range of from about 0.5 to about 2.5.

As used herein, these ranges incorporate all intermediate values between the recited endpoints. For example, a range between 0.05 and 0.2

In one aspect, w+x+y=1.0.

In one aspect, w, x, and y are each individually at least 0.05, at least 0.06, at least 0.07, at least 0.08, at least 0.09, at least 0.10, at least 0.11, at least 0.12, at least 0.13, at least 0.14, at least 0.15, at least 0.16, at least 0.17, at least 0.18, at least 0.19, at least 0.20, at least 0.21, at least 0.22, at least 0.23, at least 0.24, at least 0.25, at least 0.26, at least 0.27, at least 0.28, at least 0.29, at least 0.30, at least 0.31, at least 0.32, at least 0.33, at least 0.34, at least 0.35, at least 0.36, at least 0.37, at least 0.38, at least 0.39, at least 0.40, at least 0.41, at least 0.42, at least 0.43, at least 0.44, at least 0.45, at least 0.46, at least 0.47, at least 0.48, at least 0.49, at least 0.50, at least 0.51, at least 0.52, at least 0.53, at least 0.54, at least 0.55, at least 0.56, at least 0.57, at least 0.58, at least 0.59, at least 0.60, at least 0.61, at least 0.62, at least 0.63, at least 0.64, at least 0.65, at least 0.66, at least 0.67, at least 0.68, at least 0.69, at least 0.70, at least 0.71, at least 0.72, at least 0.73, at least 0.74, at least 0.75, at least 0.76, at least 0.77, at least 0.78, at least 0.79, at least 0.80, at least 0.81, at least 0.82, at least 0.83, at least 0.84, at least 0.85, at least 0.86, at least 0.87, at least 0.88, or at least 0.89.

In one aspect, w, x, and y are each individually at most 0.06, at most 0.07, at most 0.08, at most 0.09, at most 0.10, at most 0.11, at most 0.12, at most 0.13, at most 0.14, at most 0.15, at most 0.16, at most 0.17, at most 0.18, at most 0.19, at most 0.20, at most 0.21, at most 0.22, at most 0.23, at most 0.24, at most 0.25, at most 0.26, at most 0.27, at most 0.28, at most 0.29, at most 0.30, at most 0.31, at most 0.32, at most 0.33, at most 0.34, at most 0.35, at most 0.36, at most 0.37, at most 0.38, at most 0.39, at most 0.40, at most 0.41, at most 0.42, at most 0.43, at most 0.44, at most 0.45, at most 0.46, at most 0.47, at most 0.48, at most 0.49, at most 0.50, at most 0.51, at most 0.52, at most 0.53, at most 0.54, at most 0.55, at most 0.56, at most 0.57, at most 0.58, at most 0.59, at most 0.60, at most 0.61, at most 0.62, at most 0.63, at most 0.64, at most 0.65, at most 0.66, at most 0.67, at most 0.68, at most 0.69, at most 0.70, at most 0.71, at most 0.72, at most 0.73, at most 0.74, at most 0.75, at most 0.76, at most 0.77, at most 0.78, at most 0.79, at most 0.80, at most 0.81, at most 0.82, at most 0.83, at most 0.84, at most 0.85, at most 0.86, at most 0.87, at most 0.88, at most 0.89, or at most 0.90.

In one aspect, z is at least 0.5, at least 1.0, at least 1.5, or at least 2.0. In one aspect, z is at most 1.0, at most 1.5, at most 2.0, or at most 2.5.

In one aspect, the electrocatalyst has a rutile crystalline structure.

In one aspect, the electrocatalyst is configured for catalysis of an anodic reaction in an acidic electrolyte. In one aspect, the anodic reaction is selected from the group consisting of the oxygen evolution reaction, the chlorine evolution reaction, alcohol oxidations, and combinations thereof. In one aspect, the acidic electrolytes are selected from the group consisting of inorganic acids, organic acids, acidic polymers, and combinations thereof.

A system comprising the electrocatalyst according to claim 1, wherein the system is selected from the group consisting of proton-exchange membrane electrolyzers, electrochemical carbon capture systems, oxygen generators, metal-air batteries, electro-synthesis devices, chlor-alkali processes, and combinations thereof.

These electrocatalysts are oxides that exhibit nanoscale crystalline structures, conductivity, and high activity towards anodic reactions in acidic electrolytes. Low amounts of iridium or ruthenium are needed to synthesize them, and they exhibit long-term operational stability.

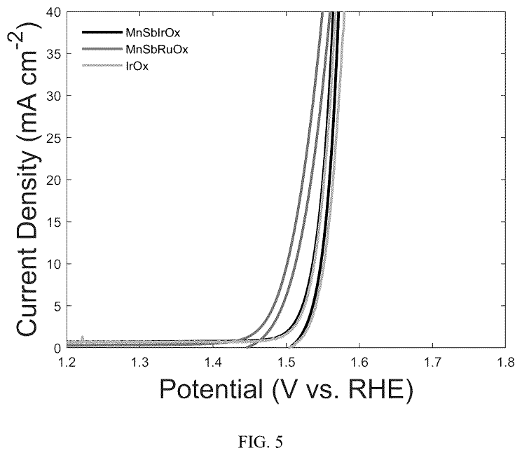

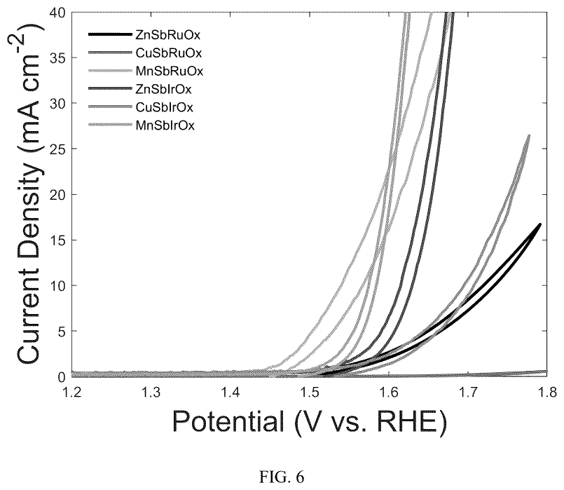

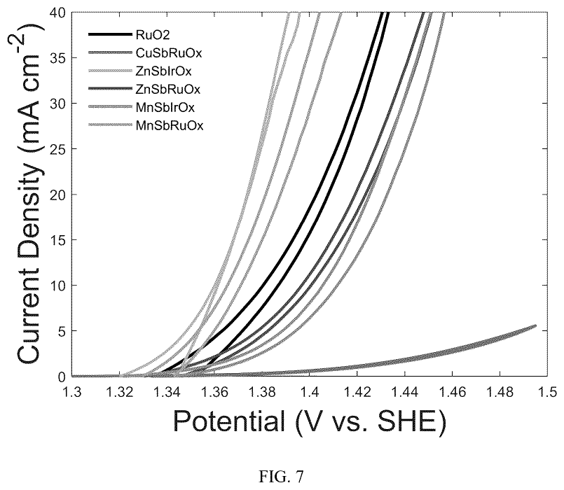

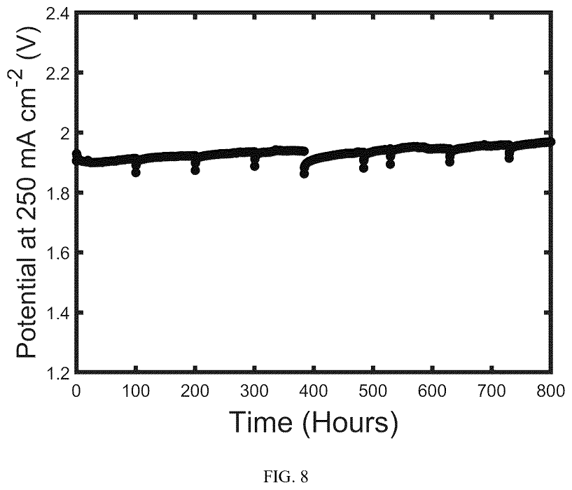

The electrocatalysts provided herein exhibit two key properties compared to state-of-the-art electrocatalysts such as iridium oxide or ruthenium oxide. Their composition greatly reduces the amount of iridium or ruthenium needed to achieve similar performance metrics as pure noble metal oxides, and their structure leads to enhanced stability compared to iridium oxide or ruthenium oxide. The materials are active for reactions such as the oxygen evolution reaction and the chloride evolution reaction (see, e.g., FIGS. 5-8). These two reactions are operated at industrial scales and currently rely on iridium or ruthenium oxides. These materials could greatly reduce the amount of iridium needed to construct electrochemical devices and facilitate the global adoption of renewable energy technologies.

Another aspect of the present disclosure provides methods of making said electrocatalyst.

The electrocatalysts provided herein can be made with any method that brings the constituent elements in close proximity and allows them to react. In some embodiments, the methods further comprise heating the constituent elements or providing chemical energy via other means to accelerate the reaction. Suitable examples of such means include, but are not limited to, annealing salts of the constituent elements in an oxygen atmosphere, annealing of metal or oxide films of the constituent elements, or annealing physical mixtures of the constituent oxides.

In another aspect, the present disclosure provides a method of making an electrocatalyst comprising a first-row transition metal, antimony, a noble metal, and oxygen. The method comprises incorporating the noble metal into a precursor framework comprising the first-row transition metal, antimony, and oxygen.

In one aspect, the method further comprises purifying the electrocatalyst.

In one aspect, the purifying comprises a technique selected from the group consisting of washing, centrifuging, sonication, and combinations thereof.

In one aspect, the electrocatalyst has a rutile crystalline structure.

In one aspect, the incorporating is achieved via a molten salt synthesis method. The molten salt synthetic method includes loading alkali metal salts or alkali earth metal with chemical precursors and annealing under high temperatures.

In yet another aspect, the present disclosure provides methods of using the provided electrocatalysts in industrial applications including, but not limited to, (i) as proton-exchange membrane electrolyzers; (ii) electrochemical carbon capture systems; (iii) oxygen generations; (iv) metal-air batteries; (v) electro-synthesis devices; (vi) chlor-alkali processes, and the like.

In yet another aspect, the present disclosure provides a method of using an electrocatalyst, comprising: a first-row transition metal; antimony; a noble metal; and oxygen. The method comprises catalyzing an industrial application with the electrocatalyst.

In one aspect, catalyzing the industrial application comprises catalyzing an anodic reaction in an acidic electrolyte. In one aspect, the acidic electrolyte is selected from the group consisting of inorganic acids, organic acids, acidic polymers, and combinations thereof. In one aspect, the anodic reaction is selected from the group consisting of oxygen evolution reaction, the chlorine evolution reaction, alcohol oxidations, and combinations thereof.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever. The starting material for the following Examples may not have necessarily been prepared by a particular preparative run whose procedure is described in other Examples. It also is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

### Example 1. Initial Catalyst Results

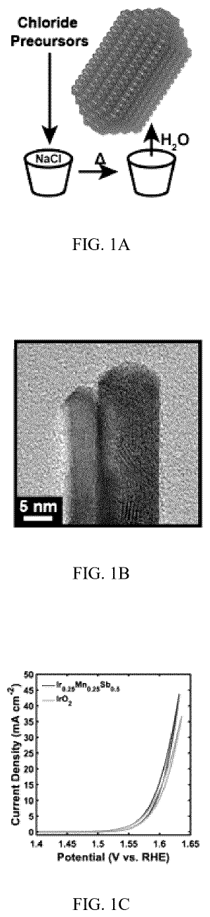

To synthesize nanocrystals in accordance with the present disclosure, proposed is a molten salt synthetic method (FIG. 1A). It is hypothesized that the sodium chloride salt matrix can provide support to the metal chloride precursors to oxidize, via diffusion of atmospheric oxygen, to the desired noble metal MnSb₂Oₓ nanocrystals. Preliminary work has shown the ability to synthesize rutile-type oxide nanocrystals with a molten salt synthesis method that incorporates a noble metal into a manganese antimony oxide lattice. To retrieve the nanocrystals from the salt matrix, the salt can simply be dissolved leaving behind the nanocrystals, which can be further purified through washing and centrifugation, resulting in ligand-free dispersions of the noble metal MnSb₂Oₓ nanocrystals. Furthermore, preliminary work has demonstrated that one can synthesize a highly crystalline noble metal MnSb₂Oₓ (FIG. 1B) that exhibits improved activity from that of pure IrO₂ (FIG. 1C), while also possessing a high level of stability at high current densities of 250 mA cm⁻² (FIG. 1D).

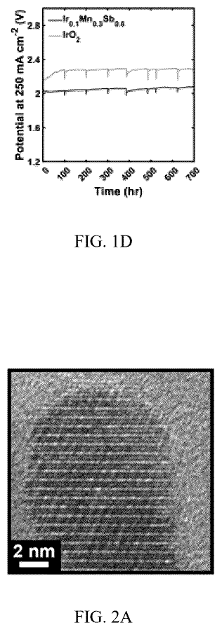

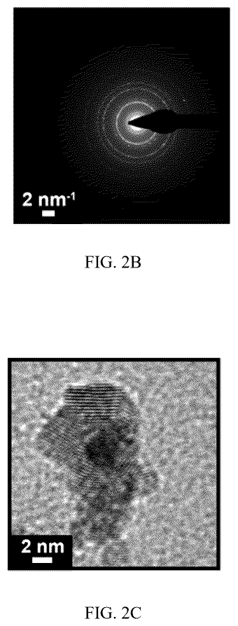

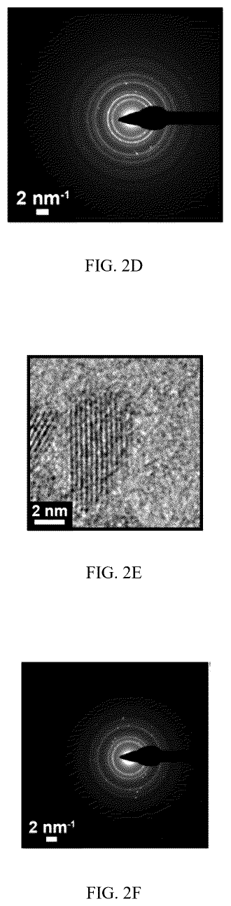

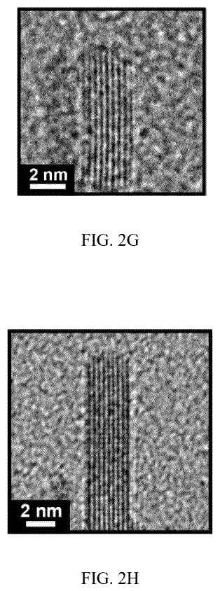

High-resolution TEM images show that the synthesized noble metal MnSb₂Oₓ particles are crystalline and that the lattice planes are clearly visible (FIG. 2). Electron diffraction indicates that the molten salt synthetic method resulted in phase-pure and crystalline nanoparticles. Furthermore, electron diffraction suggests that the noble metal MnSb₂Oₓ samples exhibited a rutile-like structure, while samples consisting of manganese antimony oxide without noble metals exhibited a non-rutile structure. The lattice spacing of the nanocrystals can be measured and resulted in a spacing of ˜3.3 Å for the noble metal MnSb₂Oₓ and a larger spacing of 6.6 Å for MnSb₂O₆. This change in lattice structure after the addition of a noble metal further indicates a substantial change in crystal structure after noble metal incorporation in a manganese antimony oxide electrocatalyst support. Preliminary elemental analysis was conducted with energy dispersive spectroscopy done in a scanning electron microscope (SEM-EDS) confirming the presence of the noble metals throughout the manganese antimony oxide framework. It was also observed that the Ir_{0.25}Mn_{0.25}Sb_{0.5}O₂ and Ru_{0.25}Mn_{0.25}Sb_{0.5}O₂ samples tended to form nanoclusters rather than faceted single nanocrystals, which the noble metal dioxide samples more readily formed. These variations in morphology between the noble metal dioxides and the noble metal MnSb₂Oₓ is further evidence of the successful incorporation of the noble metals. Thus, through TEM characterization, along with the complementary techniques, it can be concluded that the incorporation of the noble metal into the manganese antimony oxide framework through the molten salt synthetic method was successful.

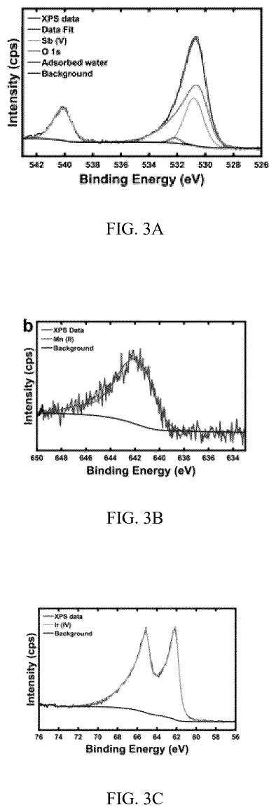

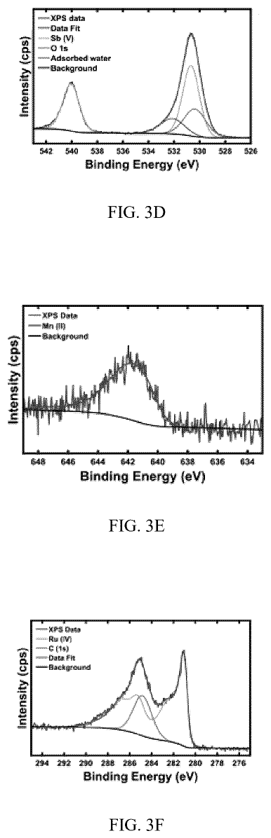

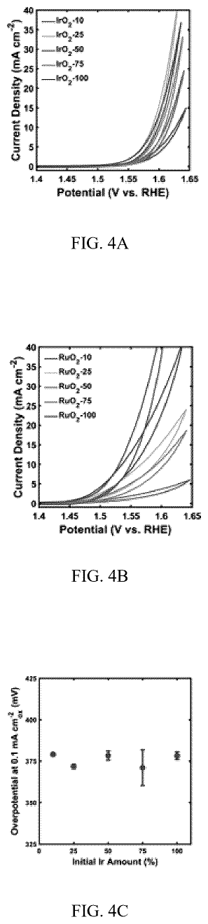

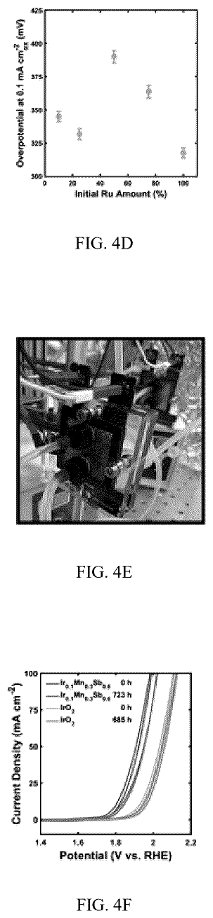

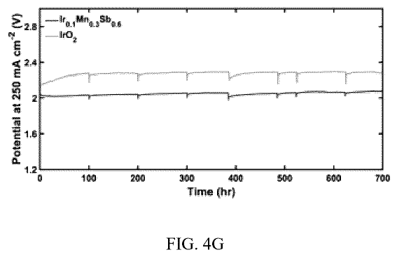

To further characterize the chemical makeup of the synthesized nanocrystals XPS was utilized. For the Ir_{0.25}Mn_{0.25}Sb_{0.5}Oₓ sample the Ir 4f region (FIG. 3C) can be completely attributed to previously established fits for Ir(IV) and the oxygen signal (FIG. 3A) is attributed to lattice oxygen and adsorbed water. For the Ru_{0.25}Mn_{0.25}Sb_{0.5}O₂ sample the Ru 3d spectrum (FIG. 3F) can be fully attributed to Ru(IV) and adventitious carbon. The Sb 3d region (FIG. 3A) shows that only Sb(V) signal is detected, which is consistent with a tri-rutile crystalline structure. This same trend is also seen in the Ru_{0.25}Mn_{0.25}Sb_{0.5}O₂ nanocrystals (FIG. 4D) however the MnSb₂O₆ framework exhibited peaks for both the +3 and +5 Sb oxidation states. The Mn 2p region for Ir_{0.25}Mn_{0.25}Sb_{0.5}Oₓ (FIG. 3B) can be completely attributed to established Mn(II) and the Mn 2p for Ru_{0.25}Mn_{0.25}Sb_{0.5}Oₓ (FIG. 3E) can also be completely attributed to Mn(II). This trend differs from what was seen in the Mn 2p region for the manganese antimony oxide framework which showed peaks that were fit to both Mn(II) and Mn(III). These changes in oxidation between the MnSb₂O₆ framework and the noble metal MnSb₂Oₓ is further evidence of substantial chemical and structural changes after noble metal incorporation into the manganese antimony oxide framework. The preliminary structural and chemical characterization data indicates that the molten salt synthetic method is viable for creating noble metal MnSb₂Oₓ nanocrystals that are phase-pure, exhibit well-defined chemical oxidation states and are ligand free.

It was hypothesized that the noble metal MnSb₂Oₓ will maintain an electrochemical activity that is comparable to that of a pure noble metal while greatly reducing the amount of noble metal present in the material. Preliminary data indicates that the synthesized noble metal MnSb₂O, is highly active and comparable to that of the pure noble metal oxides (FIGS. 4A-4B). In the Ir-doped MnSb₂Oₓ samples, Ir_{0.25}Mn_{0.25}Sb_{0.5}O₂, Ir_{0.5}Mn_{0.167}Sb_{0.33}O₂, and IrO₂ all exhibit Tafel slopes of 46 mV decade⁻¹ while Ir_{0.75}Mn_{0.083}Sb_{0.167}O₂ resulted in a slightly lower Tafel slope of 43 mV decade⁻¹. The normalized overpotential at 0.1 mA cm⁻²ₒₓ shows that reduced iridium samples exhibit intrinsic activity that is similar to pure iridium oxide. The Ir_{0.25}Mn_{0.25}Sb_{0.5}O₂ sample exhibited a normalized overpotential of 371 mV, and IrO₂ exhibited a higher overpotential of 378 mV (FIG. 4C). For the Ru-doped MnSb₂Oₓ samples series, a pure RuO₂ electrocatalysts exhibits the lowest Tafel slope of 47.6 mV decade⁻¹ and is closely followed by Ru_{0.1}Mn_{0.3}Sb_{0.6}O₂, which only exhibits a slight increase to 60.0 mV decade⁻¹. The normalized overpotential at 0.1 mA cm⁻²ₒₓ shows a similar trend where pure RuO₂ has the lowest overpotential at 318 mV while Ru_{0.25}Mn_{0.25}Sb_{0.5}O₂ and Ru_{0.1}Mn_{0.3}Sb_{0.6}O₂ processed overpotentials of 332 mV and 345 mV, respectively (FIG. 4D). While there is a slight increase in Tafel slope and overpotential it is not as significant of a change as one might expect from the substantial decrease in the amount of Ru used in the synthesis of these compounds. This is an indication that these new materials successfully incorporate the ruthenium active sites into the MnSb₂O₆ framework and greatly enhance the utilization of critical materials. These findings show that the relative amount of noble metal used in these nanocrystals can be greatly decreased yet their electrochemical activity remains relatively consistent or even improves as observed in the Ir-doped MnSb₂Oₓ samples are quite significant, since it would enable the production of substantially more electrocatalyst material while consuming the same quantities of noble metals.

For these catalysts to be useful in an industrial setting they must be stable under relevant operating conditions for extended periods. One objective is to demonstrate the stability of the electrocatalysts under operation in a proton exchange membrane (PEM) electrolyzer (FIG. 4E). Preliminary data shows that Ir_{0.1}Mn_{0.3}Sb_{0.6}O₂ is stable under operation for over 700 hours (FIG. 5F). Cyclic voltammetry of the PEM electrolyzers with anodes constructed from the Ir_{0.1}Mn_{0.3}Sb_{0.6}O₂ nanocrystals exhibit higher performance in PEM electrolyzers compared to anodes constructed from IrO₂ nanocrystals (FIG. 4F). It can also be seen in these CVs that after ˜500 hours, there is only a minimal decrease in activity of around 25 mV at 10 mA cm⁻² for the Ir_{0.1}Mn_{0.3}Sb_{0.6}O₂ nanocrystals.

The chronopotentiometry data for Ir_{0.1}Mn_{0.3}Sb_{0.6}O₂ shows stability for 700 hours at a current density of 250 mA cm⁻² and an increase of approximately 20-30 mV was seen, further showing the high level of stability (FIG. 4G). From the chronopotentiometry data a turnover number of 146,000 was calculated, which is above the target value of 100,000. Thus, it can be concluded that the Ir-doped MnSb₂Oₓ electrocatalysts will likely possess a high level of stability under relevant operating conditions. The results provided herein help build on the preliminary findings and develop fundamental insights on the activity and stability of electrocatalysts in the Ir—Mn—Sb—O and Ru—Mn—Sb—O composition space that exhibit a rutile-like crystalline structure.

### Example 2. Manganese Iridium Antimony Oxide (MISO) and Manganese Ruthenium Antimony Oxide (MRSO) Nanocrystals

### Synthesis.

Manganese-iridium antimony oxide (MISO) and manganese-ruthenium antimony oxide (MRSO) nanocrystals were synthesized using a molten salt synthesis method. A high-form porcelain crucible was loaded with approximately 4.55 g of NaCl followed by 400 mM Na₂SO₄ (500 μL), 80 mM NMCl₂ (NM=Ru, Ir) (500 μL), and specific volumes of 400 mM MnCl₂ and 320 mM SbCl₃ corresponding to specific noble metal loadings (10%, 25%, 50%, 75%). Specifically, 300, 100, 33, and 11 μL of MnCl₂ and 750, 250, 83, and 28 μL of SbCl₃ were added to obtain noble metal loadings of 10, 25, 50, and 75%, respectively. The mixture was stirred until homogenous and heated to 500 or 700° C. for 1 hour, with a temperature increase rate of 20° C. min⁻¹. The reaction mixture was cooled to room temperature and the contents were washed with ultrapure water (35 mL) followed by centrifugation to recollect the product. 2 M HCl (1 mL) was added to the nanopowder and heated to 90° C. for 1 hr in a hot water bath to remove impurities. The product was recollected again through centrifugation at 6000 RPM for 2 min and washed with IPA (1 mL) followed by centrifugation to recollect product. The resulting black powder was allowed to dry under vacuum.

### Characterization.

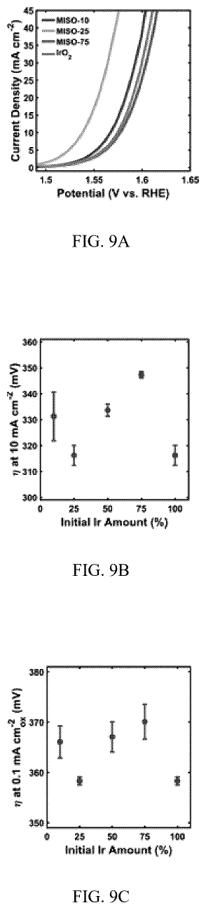

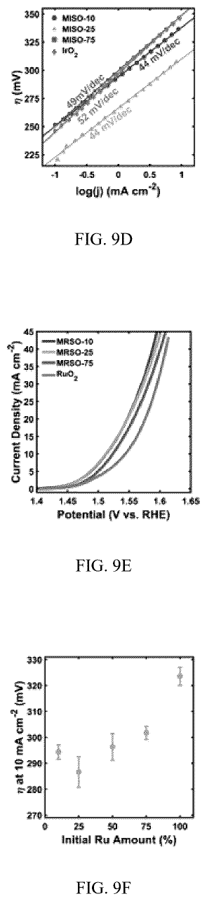

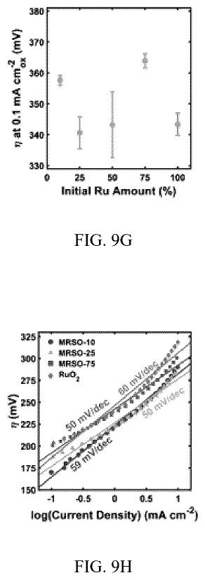

FIGS. 9A-9H show the catalytic activity of MISO and MRSO electrocatalysts synthesized at 700° C. towards the OER at a catalyst loading of 500 μg cm⁻² in 1.0 M perchloric acid at an electrolyte temperature of 25° C. The initial amount of iridium or ruthenium loaded during synthesis was found to substantially influence the electrochemical properties of the resulting materials. Scanning electron microscopy X-ray energy dispersive spectroscopy (SEM-EDS) indicated enrichment of iridium and ruthenium during synthesis that resulted in nanocrystals that exhibited iridium and ruthenium amounts between 36% and 91%. Nanocrystals of IrO₂ exhibited an overpotential of 346±4 mV at 10 mA cm⁻², an intrinsic overpotential of 360±3 mV at 0.1 mA cm⁻² of electrochemically active surface area, and a Tafel slope of 50±2 mV dec⁻¹ between 1 and 10 mA cm⁻² (FIGS. 9A-9D). MISO nanocrystals synthesized with an initial amount of iridium between 25% (MISO-25) and 75% (MISO-75) exhibited an improvement in activity as iridium loading decreased (FIGS. 9A-9C). In particular, MISO-25 resulted in an overpotential of 316±4 mV at 10 mA cm⁻² and an intrinsic overpotential of 358±1 mV at 0.1 mA cm⁻² of electrochemically active surface area. SEM-EDS analysis indicated an Ir:Mn:Sb stoichiometry of 1:0.3:0.07 for MISO-25, corresponding to 72% Ir metal basis. The decrease in overpotential could be due to extrinsic factors, such as surface area enhancement, or intrinsic factors that improve the activity of catalytic active sites. The roughness factor of MISO decreased from 552±34 to 256±30 as iridium loading increased from 25% to 75%. The surface area-normalized intrinsic overpotential of MISO increased from 358±1 mV to 370±3 mV as initial iridium loading increased from 25% to 75% (FIG. 9C). Synthesis of MISO with 10% iridium loading (MISO-10) resulted in an overpotential of 331±9 mV at 10 mA cm⁻² and an intrinsic overpotential of 366±3 mV at 0.1 mA cm⁻² of electrochemically active surface area. MISO and IrO₂ exhibited Tafel slopes between 43 and 50 mV dec⁻¹ at a current density range between 0.1 and 10 mA cm⁻² (FIG. 9D). The results indicate that MISO-25 electrocatalysts result in increased activity and lower iridium utilization compared to IrO₂, and initial iridium amount can further be reduced with MISO-10 while retaining activity similar to IrO₂.

FIGS. 9E-9H show the electrochemical properties of MRSO and RuO₂ nanocrystals synthesized at 700° C. towards the OER at a catalyst loading of 500 μg cm⁻² in 1.0 M perchloric acid at an electrolyte temperature of 25° C. RuO₂ nanocrystals exhibit an overpotential of 324±3 mV at 10 mA cm⁻², and MRSO nanocrystals exhibit overpotentials between 287 mV and 301 mV at 10 mA cm⁻². In particular, MRSO nanocrystals synthesized with an initial ruthenium loading of 25% (MRSO-25) exhibit an overpotential of 287±6 mV at 10 mA cm⁻² and an intrinsic overpotential of 341±5 mV at 0.1 mA per cm² of electrochemically active surface area. SEM-EDS analysis indicated a Ru:Mn:Sb stoichiometry of 1:0.5:0.56 for MISO-25, corresponding to 49% Ru metal basis. MRSO electrocatalysts and RuO₂ exhibit Tafel slopes between 50 and 61 mV dec⁻¹. The results indicate that the MRSO electrocatalyst can exhibit improved activity towards the OER compared to RuO₂. Manganese antimonate nanocrystals synthesized without iridium or ruthenium did not exhibit substantial activity towards the OER at potentials up to 1.6 V vs. RHE.

The electrochemical properties of MISO and MRSO nanocrystals synthesized at 500° C. and 700° C. were evaluated at a catalyst loading of 125 μg cm⁻². MISO-75 nanocrystals synthesized and IrO₂ exhibited improved overpotential at a synthesis temperature of 500° C. compared to 700° C. The activity improvements could be attributed to surface area enhancements as indicated by similar intrinsic overpotentials. MISO nanocrystals synthesized with an initial iridium amount of 25% and 50% exhibited similar overpotentials and intrinsic overpotentials. The Tafel slope of MISO nanocrystals increased as synthesis temperature increased for all initial iridium amounts expect for 10% iridium. MRSO nanocrystals exhibited substantial differences in activity trends as synthesis temperature decreased from 700° C. to 500° C. MRSO nanocrystals synthesized at an initial ruthenium amount of 50% and a synthesis temperature of 700° C. exhibited improved activity towards the OER compared to RuO₂ in extrinsic activity, intrinsic activity, and Tafel slope measurements. Nanocrystals of MRSO synthesized at 500° C. exhibited decreased extrinsic and extrinsic activity compared to RuO₂ synthesized at 500° C. Overall, the results indicate that nanocrystals synthesized at 700° C. result in electrocatalysts that exhibit improved activity due to synergistic interactions between manganese antimony oxide (MnSbOₓ) and noble metal oxides.

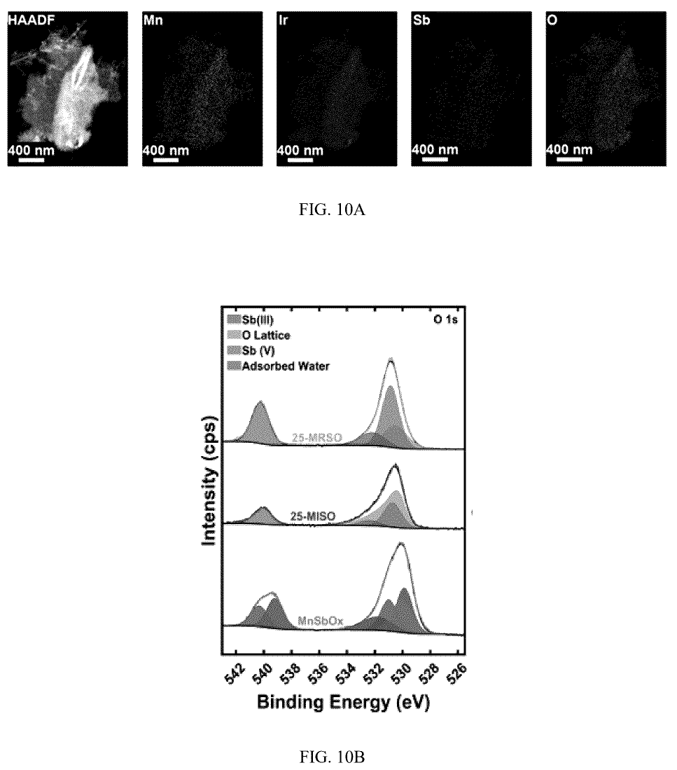

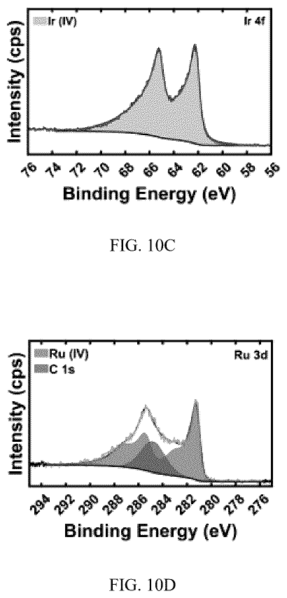

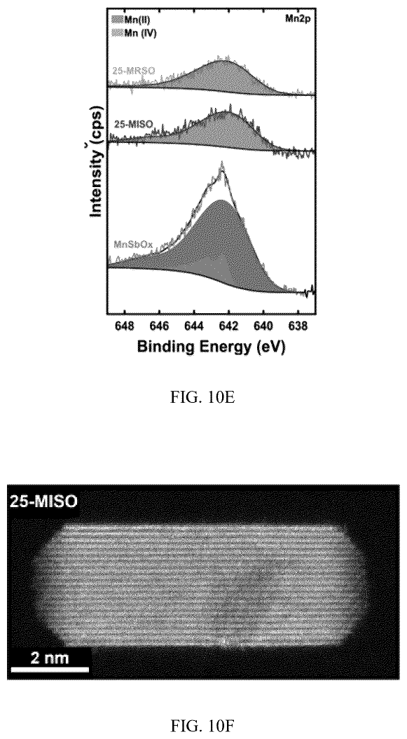

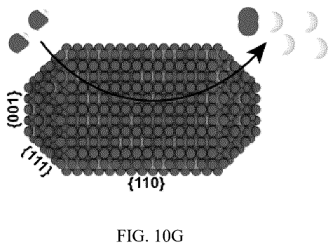

FIGS. 10A-10G show nanocrystal characterization with electron microscopy and X-ray based techniques for MISO and MRSO electrocatalysts. Scanning electron microscopy energy-dispersive spectroscopy (STEM-EDS) mapping of MISO-25 synthesized at 700° C. indicated uniform distributions of Mn, Ir, Sb, and O throughout most of the nanocrystal domains. Nanocrystals with decreased Mn and Sb content, and nanocrystals with decreased Ir content could be found with STEM-EDS, but they constituted a minor contribution of the overall ensemble. X-ray photoelectron spectroscopy (XPS) confirmed that MnSbOₓ solely consisted of Mn, Sb, and O, and that MISO-25 incorporated Ir, and that MRSO-25 incorporated Ru. XPS in the Sb 3d/O Is, Ir 4f, Ru 3d, and Mn 2p region of MnSbOₓ, MISO-25, and MRSO-25 indicated substantial differences in elemental oxidation states with the introduction of noble metals in the electrocatalyst structure (FIGS. 10B-10E). MnSbOₓ exhibits Sb(III) and Sb(V) oxidation states, whereas MISO-25 and MRSO-25 solely consist of Sb(V) (FIG. 10B). MISO-25 and MRSO-25 could be fully described with Ir(IV) and Ru(IV) contributions, respectively (FIGS. 10C-10D). MnSbOₓ exhibited contributions from Mn(II) and Mn(IV), while MISO-25 and MRSO-25 could be described solely by Mn(II) contributions (FIG. 10E). The surface stoichiometry determined from XPS of MnSbOₓ is 1:0.20 Mn:Sb, indicating an average Mn-rich surface. The surface stoichiometry of MISO-25 was 1:0.5:0.23 Ir:Mn:Sb, corresponding to 58% Ir metal basis, and the surface stoichiometry of MRSO-25 was 1:1.1:1.7 Ru:Mn:Sb, corresponding to 25% Ru metal basis. X-ray photoelectron spectroscopy of MISO-25 and MRSO-25 synthesized at 500° C. indicated the presence of the same oxidation states and similar atomic ratio as observed for the samples synthesized at 700° C. X-ray diffraction (XRD) of MnSbOₓ indicated the formation of a tri-rutile species. XRD of MISO-25 indicated a rutile-type crystal structure with lattice parameters of a=b=4.51 Å and c=3.12 Å, corresponding to a 1.2% lattice contraction along the c axis. XRD of MRSO-25 indicated a rutile-type crystal structure with lattice parameters of a=b=4.49 Å and c=3.09 Å, corresponding to a 0.53% lattice contraction along the c axis. Electron diffraction of MnSbOₓ indicated that a non-rutile crystal structure formed. High resolution transmission electron microscopy shows the formation of highly crystalline faceted nanocrystals with lattice spacing consistent with a rutile structure.

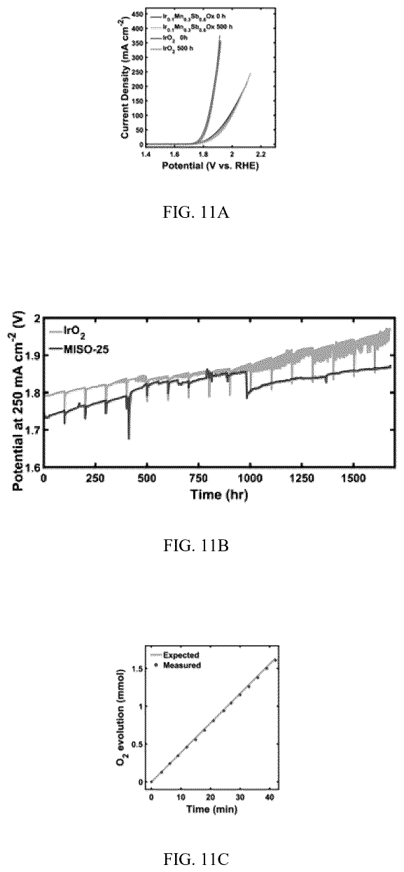

The performance of MISO nanocrystals for PEM electrolysis was determined as shown in FIGS. 11A-11C. Membrane electrode assemblies (MEA) were prepared with MISO-10, MISO-25, and IrO₂ nanocrystals. The catalyst loading of the MISO-10 MEA was 2.6 mg cm⁻², with an expected iridium loading of 1.76 mg cm⁻² based on SEM-EDS analysis. The MISO-25 MEA had a catalyst loading of 3.3 mg cm⁻² and an expected iridium loading of 2.43 mg cm⁻². An IrO₂ MEA was prepared with a similar catalyst loading of 2.8 mg cm⁻², corresponding to an iridium loading of 2.40 mg cm⁻². FIG. 11A shows the resistance-corrected activity of MISO and IrO₂ MEAs in an electrolyzer operated at room temperature with pure water fed on the anode side. The IrO₂ MEA exhibited an initial potential of 1.65 V at a current density of 100 mA cm⁻², and a mass activity of 13.6 Å per gram of Ir at a resistance-corrected potential of 1.6 V. The MISO-10 MEA exhibited an initial potential of 1.79 V at a current density of 100 mA cm⁻², and a mass activity of 5.3 Å per gram of Ir at a resistance-corrected potential of 1.6 V. The MISO-25 MEA exhibited an initial potential of 1.61 V at a current density of 100 mA cm⁻², and a mass activity of 36.4 Å per gram of Ir at a resistance-corrected potential of 1.6 V. Faradaic efficiency of the electrolyzers was near 100% within experimental as determined via eudiometer measurements (FIG. 11C). The MEAs were operated at a constant current density of 250 mA cm⁻², and the electrolyzer potential was corrected for initial series resistance as shown in FIG. 11B. The IrO₂ electrolyzer exhibited a gradual increase in potential throughout the stability study, with an average increase in potential of 107 μV per hour from 50 to 500 hours of operation and an average resistance-corrected potential of 1.83 V (FIG. 11B). The electrolyzer constructed with the MISO-10 MEA operated for over 700 hours, exhibited an average resistance-corrected potential of 2.04 V throughout the stability study, and exhibited an increase in potential of 30 μV per hour from 50 to 500 hours of operation (FIG. 11B). The electrolyzer constructed with the MISO-25 MEA operated for over 700 hours, exhibited an increase in potential of 63 μV per hour from 50 to 500 hours of operation (FIG. 11B). The water reservoir for an electrolyzer prepared with a MISO-25 MEA was analyzed with inductively-coupled mass spectrometry (ICP-MS) to further assess electrocatalyst stability. Sampling of the water reservoir after constant water cycling for 24 hours with no applied potential indicated that minimal material loss occurred with only 0.338 nanomoles of Ir, 1.69 nanomoles of Sb, and 0.215 nanomoles of Mn being detected in the water reservoir. Subsequent operation of the MISO-25 electrolyzer for 234 hours at 250 mA cm⁻² resulted in the generation of 0.4923 moles of O₂ and the detection of an additional 0.458 nmol of Mn (0.08%), 0.457 nmol of Ir (0.007%), and 16.3 nmol of Sb (2.2%) in the water reservoir.

The stability number, which corresponds to the moles of O₂ evolved per moles of Ir detected, was determined to be 1.07×10⁹ for the MISO-25 electrolyzer for the overall dissolution study. The dissolution rates of Ir, Mn, and Sb were found to decrease with time, with the Ir dissolution rate being 0.613 picomoles per hour from 181 to 234 hours of operation, corresponding to a stability number of 3.43×10⁹ in this time range. The reported stability number for IrO₂-based PEM electrolyzers is 6.73×10⁸, indicating that MISO-25 could exhibit an 80% reduction in iridium loss during operation.

### DISCUSSION

The high synthesis temperatures necessary to crystallize transition metal antimonates has typically limited studies to thin films or microcrystalline powders. This work demonstrates an approach to synthesized nanocrystalline samples of transition metal antimonates with a salt matrix that prevents nanocrystal aggregation, which enables efficient utilization of scarce elements and the study of nanoscale effects that could impact electrocatalyst activity and stability. In general, the morphology of MISO and MRSO nanocrystals resulted in high-aspect ratio structures that preferentially expose (110) crystallographic facets of a rutile-type structure.

Noble metal incorporation resulted in uniformly dispersed Ir or Ru in the nanocrystalline lattice, which could result in Ir or Ru with neighboring Mn and Sb atoms that substantially influence catalytic activity. Changes in intrinsic overpotential and Tafel slope for MISO and MRSO indicate that the catalytic active site for OER is substantially affected by Mn and Sb incorporation.

Substantial enrichment of noble metals was observed in the synthesized catalysts compared to the elemental ratios of starting synthesis reagents. In general, noble metal oxides can crystallize at a substantially lower temperature compared to manganese antimony oxide. The present synthesis procedure involves exposing synthesized samples to acidic conditions prior to testing to remove amorphous impurities, which could result in the removal of amorphous MnSbOₓ from the catalyst ensemble. The results indicate that careful analysis of elemental composition with materials characterization methods is necessary to elucidate precise compositions for TMA electrocatalysts.

In general, electrocatalyst that reduce iridium utilization often suffer from decreased activity due to dilution of OER active sites in an OER-inactive matrix. Prior work has shown that manganese antimonate films exhibit moderate activity towards the OER, suggesting that this moderate activity amplifies the activity if Ir-based active sites compared to inactive materials such as TiO₂.

In summary, manganese iridium antimony oxide nanoparticles were successfully synthesized as a low-iridium electrocatalyst. 25-MISO-700° C. exhibited a low overpotential of 316±4 mV at 10 mA cm⁻² with an excellent mass activity. This increase in activity is attributed to an improvement in the intrinsic stability of the active sites. It also exhibited a high level of stability under operation maintaining stability at a current density of 250 mA cm⁻². Overall, the good activity and excellent stability make the MISO catalysts an efficient and stable low iridium substitute as an electrocatalyst for the OER in acidic conditions. These findings show that low noble metal TMAs are promising OER electrocatalysts and can be successfully implemented into MEAs.

### CONCLUSIONS

Overall, a low noble metal electrocatalyst that exhibits improved activity and stability for the oxygen evolution reaction compared to its pure noble metal counterparts was developed. TMA materials could allow for the next-generation of electrocatalyst to be developed.

### Embodiments

Further aspects of the invention are provided by the subject matter of the following clauses. These clauses may be combined in any permutation or combination.
1. An electrocatalyst, comprising:
a first-row transition metal;
antimony;
a noble metal; and
oxygen.
2. The electrocatalyst according to the preceding clause, wherein the first-row transition metal is selected from the group consisting of titanium (Ti), vanadium (V), chromium (Cr), manganese (Mn), iron (Fe), cobalt (Co), nickel (Ni), copper (Cu), zinc (Zn), and combinations thereof.
3. The electrocatalyst according to any preceding clause, wherein the noble metal is selected from the group consisting of ruthenium (Ru), rhodium (Rh), palladium (Pd), silver (Ag), osmium (Os), iridium (Ir), platinum (Pt), gold (Ag), and combinations thereof.
4. The electrocatalyst according to any preceding clause, wherein the noble metal comprises ruthenium (Ru) and/or iridium (Ir).
5. The electrocatalyst according to any preceding clause, wherein the electrocatalyst has a chemical composition according to Formula I:

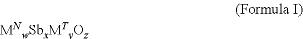

wherein:
M^{N} represents the noble metal;
M^{T} represents the first-row transition metal;
w is in a range of from about 0.05 to about 0.90;
x is in a range of from about 0.05 to about 0.90;
y is in a range of from about 0.05 to about 0.90; and
z is in a range of from about 0.5 to about 2.5.
6. The electrocatalyst according to any preceding clause, wherein the electrocatalyst has a rutile crystalline structure.
7. The electrocatalyst according to any preceding clause, wherein the electrocatalyst is configured for catalysis of an anodic reaction in an acidic electrolyte.
8. The electrocatalyst according to any preceding clause, wherein the anodic reaction is selected from the group consisting of the oxygen evolution reaction, the chlorine evolution reaction, alcohol oxidations, and combinations thereof.
9. The electrocatalyst according to any preceding clause, wherein the acidic electrolytes are selected from the group consisting of inorganic acids, organic acids, acidic polymers, and combinations thereof.
10. A system comprising the electrocatalyst according to any preceding clause, wherein the system is selected from the group consisting of proton-exchange membrane electrolyzers, electrochemical carbon capture systems, oxygen generators, metal-air batteries, electro-synthesis devices, chlor-alkali processes, and combinations thereof.
11. A method of making an electrocatalyst, comprising:
a first-row transition metal;
antimony;
a noble metal; and
oxygen,
the method comprising:
incorporating the noble metal into a precursor framework comprising the first-row transition metal, antimony, and oxygen.
12. The method according to the preceding clause, further comprising purifying the electrocatalyst.
13. The method according to any preceding clause, wherein the purifying comprises a technique selected from the group consisting of washing, centrifuging, sonication, and combinations thereof.
14. The method according to any preceding clause, wherein the electrocatalyst has a rutile crystalline structure.
15. The method according to any preceding clause, wherein the incorporating is achieved via a molten salt synthesis method.
16. A method of using an electrocatalyst, comprising:
a first-row transition metal;
antimony;
a noble metal; and
oxygen,
the method comprising catalyzing an industrial application with the electrocatalyst.
17. The method according to the preceding clause, wherein catalyzing the industrial application comprises catalyzing an anodic reaction in an acidic electrolyte.
18. The method according to any preceding clause, wherein the acidic electrolyte is selected from the group consisting of inorganic acids, organic acids, acidic polymers, and combinations thereof.
19. The method according to any preceding clause, wherein the anodic reaction is selected from the group consisting of the oxygen evolution reaction, the chlorine evolution reaction, alcohol oxidations, and combinations thereof.
20. The method according to any preceding clause, wherein the electrocatalyst has a rutile crystalline structure.

### Definitions

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

As used herein, the term “rutile crystalline structure” means a crystal structure that is identical to, or substantially similar to, rutile, which has a tetragonal crystal structure characterized by edge-sharing TiO₆ octahedra forming columns, with each oxygen atom shared between two columns and bonded to three Ti atoms.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result. In some embodiments, the term “about” means plus or minus 10% of the value.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, “and/or” refers to and encompasses any and all possible combinations of one or more of the associated listed items, as well as the lack of combinations where interpreted in the alternative (“or”).

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of”.

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

As used herein, references to “example embodiment” or “one embodiment” or “some embodiments” of the present disclosure are not intended to be interpreted as excluding the existence of additional embodiments that also incorporate the recited features.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

Although specific features of various embodiments of the invention may be shown in some drawings and not in others, this is for convenience only. In accordance with the principles of the invention, any feature of a drawing may be referenced and/or claimed in combination with any feature of any other drawing.

While the invention has been described in terms of various specific embodiments, those skilled in the art will recognize that the invention can be practiced with modification within the spirit and scope of the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electrocatalyst, comprising:
a first-row transition metal;
antimony;
a noble metal; and
oxygen.

2. The electrocatalyst according to claim 1, wherein the first-row transition metal is selected from the group consisting of titanium (Ti), vanadium (V), chromium (Cr), manganese (Mn), iron (Fe), cobalt (Co), nickel (Ni), copper (Cu), zinc (Zn), and combinations thereof.

3. The electrocatalyst according to claim 1, wherein the noble metal is selected from the group consisting of ruthenium (Ru), rhodium (Rh), palladium (Pd), silver (Ag), osmium (Os), iridium (Ir), platinum (Pt), gold (Ag), and combinations thereof.

4. The electrocatalyst according to claim 1, wherein the noble metal comprises ruthenium (Ru) and/or iridium (Ir).

5. The electrocatalyst according to claim 1, wherein the electrocatalyst has a chemical composition according to Formula I: 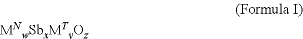
wherein:
M^{N} represents the noble metal;
M^{T} represents the first-row transition metal;
w is in a range of from about 0.05 to about 0.90;
x is in a range of from about 0.05 to about 0.90;
y is in a range of from about 0.05 to about 0.90; and
z is in a range of from about 0.5 to about 2.5.

6. The electrocatalyst according to claim 1, wherein the electrocatalyst has a rutile crystalline structure.

7. The electrocatalyst according to claim 1, wherein the electrocatalyst is configured for catalysis of an anodic reaction in an acidic electrolyte.

8. The electrocatalyst according to claim 1, wherein the anodic reaction is selected from the group consisting of the oxygen evolution reaction, the chlorine evolution reaction, alcohol oxidations, and combinations thereof.

9. The electrocatalyst according to claim 1, wherein the acidic electrolytes are selected from the group consisting of inorganic acids, organic acids, acidic polymers, and combinations thereof.

10. A system comprising the electrocatalyst according to claim 1, wherein the system is selected from the group consisting of proton-exchange membrane electrolyzers, electrochemical carbon capture systems, oxygen generators, metal-air batteries, electro-synthesis devices, chlor-alkali processes, and combinations thereof.

11. A method of making an electrocatalyst, comprising:
a first-row transition metal;
antimony;
a noble metal; and
oxygen,
the method comprising:
incorporating the noble metal into a precursor framework comprising the first-row transition metal, antimony, and oxygen.

12. The method according to claim 11, further comprising purifying the electrocatalyst.

13. The method according to claim 12, wherein the purifying comprises a technique selected from the group consisting of washing, centrifuging, sonication, and combinations thereof.

14. The method according to claim 11, wherein the electrocatalyst has a rutile crystalline structure.

15. The method according to claim 11, wherein the incorporating is achieved via a molten salt synthesis method.

16. A method of using an electrocatalyst, comprising:
a first-row transition metal;
antimony;
a noble metal; and
oxygen,
the method comprising catalyzing an industrial application with the electrocatalyst.

17. The method according to claim 16, wherein catalyzing the industrial application comprises catalyzing an anodic reaction in an acidic electrolyte.

18. The method according to claim 16, wherein the acidic electrolyte is selected from the group consisting of inorganic acids, organic acids, acidic polymers, and combinations thereof.

19. The method according to claim 16, wherein the anodic reaction is selected from the group consisting of the oxygen evolution reaction, the chlorine evolution reaction, alcohol oxidations, and combinations thereof.

20. The method according to claim 16, wherein the electrocatalyst has a rutile crystalline structure.
